(19) United States
(12) Patent Application Publication
(10) Pub. No.: US 2001/0036552 A1
(43) Pub. Date: Nov. 1, 2001

(54) Ink-jet recording material suitable for pigment ink

(76) Inventors: Teiichi Otani, Tokyo (JP); Atsushi Ono, Tokyo (JP); Noboru Kondo, Tokyo (JP); Hiroyuki Onishi, Suwa-shi (JP); Masaya Shibatani, Suwa-shi (JP); Jun Sugiyama, Suwa-shi (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/820,813

(22) Filed: Mar. 30, 2001

(30) Foreign Application Priority Data
Mar. 30, 2000 (JP) 2000-094125

(51) Int. Cl. B32B 29/00; B32B 27/32; C08K 3/34; C08K 3/22

(52) U.S. Cl. 428/411.1; 524/493; 524/497; 524/444; 428/523; 428/537.5

(57) ABSTRACT

An ink-jet recording material having on a support at least the outermost ink-receiving layer and a lower ink-receiving layer, with the outermost ink-receiving layer containing as main constituents a binder and a pigment having an average particle size of 30 to 500 nm and being constituted so that all constituents contained therein show a pH value of from 6.5 to 10 as a slurry solution prepared by dispersing them homogeneously in water in a total concentration of 10% by weight, thereby providing fast images of high quality equivalent to those obtained by silver halide photography and graphic arts when multiple color printing is done thereon with an inkjet color printer using water-based pigment ink.

### FIELD OF THE INVENTION

The present invention relates to a recording material for ink-jet process using water-based pigment ink. In particular, the invention is concerned with an ink-jet recording material that has good ink absorbency and excellent color reproducing capability, can ensure uniform and high gloss in image areas, irrespective of the amount of ink struck thereinto, and enables recording of fast images.

### BACKGROUND OF THE INVENTION

Full-color and noiseless printing can be easily achieved by adopting ink-jet recording methods. In recent years, therefore, the utilization of ink-jet recording methods has been spreading at a rapid rate. According to such a method, fine drops of ink are jetted from nozzles at a high speed so as to direct toward a recording material, and a large quantity of solvent is contained in the ink used. As a result, recording materials for ink-jet recording are required to absorb ink promptly.

The recent years have also seen rapid proliferation of personal computers and digital cameras. Under these circumstances, printers as apparatus for outputting such digital image information have come to be required to produce images having qualities on a level similar to those attained by silver salt photography. Thus, it has also become necessary for ink-jet recording materials used in such printers to ensure high-density colors, high resolution and excellent color reproduction in the images printed thereon.

Solvents of ink usable for inkjet printers include aqueous (water-based) solvents and non-aqueous (organic solvent-based) solvents, but aqueous solvents have been generally used in order to prevent the orifices of inkjet nozzles from being choked up.

In the filed of full color recording in particular, ink-jet printers using as printing ink aqueous solutions of dyes of at least three different colors, or the so-called aqueous dye ink, rank as the dominant printers, because the dyes as coloring constituents of the ink are superior in point of color formation. On the other hand, ink-jet printers using as printing ink aqueous dispersions of pigments of at least three different colors, or the so-called aqueous pigment ink, are, at present, employed for specific purposes alone, centering on the printing of rough images, e.g., wide-format images including poster. This is because the images printed in such pigment ink are inferior in color reproduction though they have excellent light resistance and water resistance.

A reason why the images printed in pigment ink are inferior in color reproduction is that, when ink-jet recording paper designed placing importance on ink absorption is used for printing in pigment ink, the ink penetrates too deeply in the paper because the pigments dispersed in the ink as coloring ingredients have specific sizes, thereby causing deterioration in color density and color reproduction. On the other hand, when ink-jet recording paper is designed putting a premium on color reproduction by pigment ink, it has a drawback of being inferior in pigment ink absorption. As matters stand, therefore, no recording materials capable of ensuring both excellent color reproduction and high ink absorption when pigment ink is used are known yet.

In recent years, however, there has been a growing trend to utilize recording sheets printed in pigment ink as press proof for a reason that the strong points of pigment ink, namely excellent light- and water-resisting properties, can be taken advantage of. However, the pigment ink itself has a specific particle size, so it does not have a dyeing power such as dyes have. In most cases, therefore, it has occurred that the images printed in pigment ink had such poor fastness as to fall off when they were merely rubbed. In spite of these circumstances, almost no arts to producing ink-jet recording materials suitable for aqueous pigment ink have been disclosed yet. As only one art disclosed, there is the method disclosed in Japanese Tokkai Hei 10-119417 (the term “Tokkai” as used herein means an “unexamined published patent application”) which comprises providing a layer capable of swelling in ink. However, this method has a defect that the coating layer itself peels off when it is rubbed with fingers after printing because of its poor resistance to water.

### SUMMARY OF THE INVENTION

Therefore, an object of the invention is to provide a recording material suitable for an ink-jet process using pigment ink, which can well absorb pigment ink and ensure high color density and excellent color reproduction when images are printed thereon with an ink-jet printer using aqueous pigment ink, thereby enabling the formation of images whose qualities are equivalent to those obtained by silver halide photography and graphic arts.

The aforementioned object is attained with an ink-jet recording material suitable for pigment ink, which has on a support at least two ink-receiving layer including the outermost ink-receiving layer and a lower ink-receiving layer: with the outermost ink-receiving layer containing as main constituents a binder and a pigment having an average particle size of 30 to 500 nm and being constituted so that all constituents contained therein show a pH value of from 6.5 to 10 as a slurry solution prepared by dispersing them homogeneously in water in a total concentration of 10% by weight, thereby achieving the invention.

In accordance with the invention, a pigment specified by its particle size is incorporated in the outermost ink-receiving layer, and thereby specific voids and asperities are formed in the surface part of the coated paper. Even when a large amount of pigment ink is struck into the present recording material surface, the ink can therefore be uniformly held by the upper layer part advantageous to color formation. As a result, the images printed on the present recording material can have not only colors reproduced in a satisfactory condition but also highly uniform glossiness at the surface, and besides, the image fastness can be improved because the binder present in an ink solvent can remain in a moderate amount in the image areas.

### DETAILED DESCRIPTION OF THE INVENTION

The present recording material has no particular restrictions on a support used therein. Both transparent and opaque supports can be used therein. Examples thereof include various plastic films, such as films of cellophane, polyethylene, polypropylene, soft polyvinyl chloride, hard polyvinyl chloride and polyester, and a wide variety of paper including wood-free paper, base paper for photographic paper, drawing paper, painting paper, art paper, coated paper, cast-coated paper, craft paper, impregnated paper and synthetic paper. Depending on the desired purpose, the support for the present recording material can be selected properly from the plastic films or various paper sheets as recited above.

The present ink-jet recording material is provided with at least two ink-receiving layers. Therein, the outermost ink-receiving layer aims to ensure satisfactory color reproduction in the ink images printed thereon, while the lower ink-receiving layer or layers mainly aim to assume ink absorption. When the ink-receiving layer is a single layer, it is difficult to achieve both excellent color reproduction and high ink absorbency and ensure high-quality images. In general, printers having higher resolution are larger in the amount of ink struck into per-unit area of a recording material. So, it is required for the recording material in its entirety to have the higher ink absorptive capacity. In this respect, it is advantageous to provide a coating layer containing highly ink-absorptive pigment and binder as main constituents as the lower ink-receiving layer.

When the lower ink-receiving layer is too thin, it cannot absorb the ink solvent sufficiently. As a result, image bleeding is observed markedly in the color-mixed areas. In the case of using a too thick ink-receiving layer as the lower layer, on the other hand, the surface strength of recording material obtained becomes insufficient to cause troubles that the coating layer comes off the support in powder when the recording material stored in a rolled-up condition is unrolled and made flat or further cut into small-sized sheets, or the coating layer falls off when the printed areas are rubbed simply with fingers. Accordingly, it is appropriate that the coating layer as lower layer have a thickness of 5 to 50 μm, particularly 10 to 30 μm.

The pigment generally used in an ink-receiving layer to be provided as the lower layer is synthetic silica, but various pigments other than silica may be employed. Examples of usable pigments include inorganic pigments, such as alumina, hydrated alumina (e.g., alumina sol, colloidal alumina and psuedo-boehmite), aluminum silicate, magnesium silicate, magnesium carbonate, precipitated calcium carbonate, ground calcium carbonate, kaolin, talc, calcium sulfate, titanium dioxide, zinc oxide, zinc carbonate, calcium silicate and aluminum hydroxide, and organic pigments such as plastic pigments and urea resin powders.

For attaining the high ink absorbency aimed at, it is appropriate that a pigment having an oil absorption of 100 to 300 cc/100 g be incorporated in an amount of 50 to 100 parts by weight. When the pigment incorporated in a lower ink-receiving layer has an oil absorption smaller than 100 cc/100 g, the lower ink-receiving layer is required to have a enough thickness for covering inferiority in ink absorbency and securing the intended ink absorption capacity. As a result, there occurs a trouble that the coating layer comes off in powder. Conversely, pigments having too great oil absorption cause an increase in viscosity when they are dispersed, so such pigment dispersions cannot have a high solids concentration. As a result, operational difficulties, inclusive of a heavy load imposed on drying of the coated layer, come up.

The lower ink-receiving layer or layers in the present recording material have no particular restrictions on binders used therein. Examples of usable binders include polyvinyl alcohol and modified products thereof, polyvinyl acetate, oxidized starch, etherified starch, casein, gelatin, soybean protein, carboxymethyl cellulose, SB latex, NB latex, acrylic resin latex, ethylene-vinyl acetate copolymer latex, polyurethane and unsaturated polyester resins. Such binders may be used alone or as a mixture of two or more thereof.

The suitable amount of binder added is in the range of 5 to 60 parts by weight per 50 to 100 parts by weight of pigment as recited above. This is because the ink-receiving layer has a surface strength problem when it contains a binder in an amount smaller than 5 parts by weight, while when the amount of binder added is larger than 60 parts by weight the ink absorptive capacity of the resulting layer becomes insufficient.

The pigment incorporated in the outermost ink-receiving layer is required to have an average particle size of 30 to 500 nm, particularly preferably from 200 to 400 nm. When the average particle size is below 30 nm, there are not many voids in a layer coated although the coated layer itself can have improved transparency. As a result, the ink-receiving layer formed cannot have sufficient ink absorbency, and this shortage of ink absorbency produces serious defects in image areas, particularly in color-mixed image areas to which ink is applied in higher amounts. Further, the incorporation of a pigment having a too small average particle size causes deterioration in formability of a coating layer, and becomes a cause of producing cracks on the coating layer surface when the coating layer is thick.

When the average particle size is greater than 500 nm, on the other hand, the recording material obtained is lowered in white paper glossiness, so it feels a lot like plain paper and looks cheap. Further, the ink-receiving layer formed is subject to a deep penetration of ink, so it causes a shortage of color density in the image areas on which ink is struck in smaller amounts. Moreover, the colloidal solution of a pigment having a too large average grain size has a considerably low fluidity, and so the use of such a pigment leads to deterioration in workability and productivity.

Furthermore, the pigment present in the outermost ink-receiving layer may be a pigment comprising secondary particles formed of fine primary particles. In particular, it is advantageous for the pigment to have a form that fine primary particles are linked up into chains, rinks or chain-ring complexes. It is appropriate that the fine primary particles constituting the secondary particles have their average particle size in the range of 5 to 60 nm. The fine primary particles usable herein has no particular restriction on the species thereof. However, they are preferably fine colloidal particles, such as silica, alumina, titanium dioxide and zirconia. From the performance and handling viewpoints in particular, it is advantageous to use sol-state colloidal particles in the coating composition. When the average size of primary particles is smaller than 5 nm, deterioration of ink absorbency is caused; while, when it is greater than 60 nm, the transparency of the ink-receiving layer is lowered and excellent color reproduction is hard to obtain. In particular, the primary particles having an average size of 10 to 40 nm are preferred.

In accordance with the invention, further improved color reproduction can be achieved in the images recorded when the outermost ink-receiving layer is designed so that, when a 10 weight % slurry is prepared by shaving away the outermost ink-receiving layer and dispersing the shavings homogeneously into water, the slurry has its pH in the neutral to weak alkaline range, specifically in the range of 6.5 to 10, preferably 7.0 to 8.0. Reasons why the color reproduction of images is improved by the pH adjustment are not certain, but it can be presumed that the ink-receiving layer having too low pH affects adversely color materials of ink, while the dissolution of pigment may occur in the ink-receiving layer under too high pH conditions. The adjustment to the foregoing pH range can be effected by properly adjusting the pH of a coating composition for forming the outermost ink-receiving layer or/and by subjecting an ink-receiving layer as the outermost layer to after-treatment with an appropriate solution.

When the outermost ink-receiving layer is too thick, it tends to come off in powder. Therefore, it is appropriate that the thickness of the outermost ink-receiving layer be 50 μm or below, preferably 30 μm or below. However, when the outermost ink-receiving layer is too thin, it is inferior in the effect of reproducing colors. Accordingly, it is suitable for the outermost ink-receiving layer to have a thickness of at least 5 μm, preferably at least 10 μm.

To the ink-receiving layers according to the invention, various additives including a pigment-dispersing agent, a thickener, an antifoaming agent, a defoaming agent, a release agent, a blowing agent, a coloring dye, a coloring pigment, a fluorescent dye, a UV absorbent, an antioxidant, an antiseptic, a waterproof agent, a surfactant and a wet paper strength increasing agent can be added in appropriate amounts so far as the addition thereof does not impair the effects of the invention.

For providing the present ink-receiving layers on a support, general coating apparatus of various kinds, such as a blade coater, a roll coater, an air knife coater, a bar coater, a gate roll coater, a curtain coater, a short dwell coater, a gravure coater, a flexo gravure coater and a size press, can be used under an on-machine or off-machine condition. In addition, a transfer method can also be adopted wherein the lower ink-receiving layers are coated on a support, the outermost ink-receiving layer is coated on a film, and then these coatings are brought into face-to-face contact and bonded together.

Before providing the outermost ink-receiving layer on a lower ink-receiving layer, the lower ink-receiving layer may undergo surface treatment using a calendering apparatus, such as a machine calender, a super calender or a soft calender.

The term “pigment ink” as used herein refers to the ink containing pigments as color materials, in which a pigment dispersing agent, water as a solvent, a penetrant (surfactant), a polyhydric alcohol (high boiling organic solvent) and a low boiling organic solvent are further contained, if needed. The pigment ink applicable to the invention has no particular restrictions, but can be selected from known ones as appropriate. The pigments used therein as coloring materials can be selected from inorganic or organic pigments. Examples of such pigments include the following:

Specifically, inorganic pigments which can be used are titanium dioxide, iron oxides and carbon black produced by a known process, such as a contact process, a furnace process or a thermal process. As examples of an organic pigment which can be used, mention may be made of azo dyes (including azo lake, insoluble azo pigments, condensed azo pigments and chelate azo pigments), polycyclic pigments (e.g., phthalocyanine pigments, perylene pigments, periquinone pigments, anthraquinone pigments, quinacridone pigments, dioxazine pigments, thioindigo pigments, isoindolinone pigments and quinophthalone pigments), dye chelates (e.g., basic dye chelates and acidic dye chelates), nitro pimgents, nitroso pigments and aniline black.

Examples of carbon black used for black ink include Carbon Black No. 2300, No. 900, MCF88, No. 40, No. 45, No. 52, MA7, MA8, MA100 and No. 220QB, which are products of Mitsubishi Chemical Co., Ltd., Raven 5750, Raven 5250, Raven 5000, Raven 3500, Raven 1255 and Raven 700, which are products of Colombia Co., Ltd., Regal 400R, Regal 330R, Regal 660R, Mogul L, Monarch 700, Monarch 800, Monarch 880, Monarch 900, Monarch 1000, Monarch 1100, Monarch 1300 and Monarch 1400, which are products of Cabot Co., Ltd., and Color Black FW1, Color Black FW2, Color Black FW2V, Color Black FW18, Color Black FW200, Color Black S150, Color Black S160, Color Black S170, Printex U, Printex V, Printex 140U, Special Black 6, Special Black 5, Special Black 4A and Special Black 4, which are products of Degussa Co., Ltd.

Examples of pigments used for yellow ink include C.I.Pigment Yellow 1, C.I.Pigment Yellow 2, C.I.Pigment Yellow 3, C.I.Pigment Yellow 12, C.I.Pigment Yellow 13, C.I.Pigment Yellow 14C, C. I. Pigment Yellow 16, C. I. Pigment Yellow 17, C.I.Pigment Yellow 73, C.I.Pigment Yellow 74, C.I.Pigment Yellow 75, C.I.Pigment Yellow 83, C.I.Pigment Yellow 93, C.I.Pigment Yellow 95, C.I.Pigment Yellow 97, C.I.Pigment Yellow 98, C.I.Pigment Yellow 114, C.I.Pigment Yellow 128, C.I.Pigment Yellow 129, C.I.Pigment Yellow 151 and C.I.Pigment Yellow 154.

Examples of pigments used for magenta ink include C.I.Pigment Red 5, C.I.Pigment Red 7, C.I.Pigment Red 12, C.I.Pigment Red 48(Ca), C.I.Pigment Red 48(Mn), C.I.Pigment Red 57(Ca), C.I.Pigment Red 57:1, C.I.Pigment Red 112, C.I.Pigment Red 122, C.I.Pigment Red 123, C.I.Pigment Red 168, C.I.Pigment Red 184 and C.I.Pigment Red 202.

Examples of pigments used for cyan ink include C.I.Pigment Blue 1, C.I.Pigment Blue 2, C.I.Pigment Blue 3, C.I.Pigment Blue 15:3, C.I.Pigment Blue 15:34, C.I.Pigment Blue 16, C.I.Pigment Blue 22, C.I.Pigment Blue 60, C.I.Vat Blue 4 and C.I.Vat Blue 60.

For dispersing the pigments as recited above, pigment-dispersing agents can be used, if needed. As examples of pigment-dispersing agents usable therefor, mention may be made of polymeric dispersants and surfactants. The suitable polymeric dispersants are water-soluble styrene (meth)acrylic acid resins, with examples including styrene-acrylic acid copolymer, styrene-methacrylic acid copolymer, styrene-methacrylic acid-alkyl acrylate copolymers, styrene-α-methylstyrene-acrylic acid copolymer and styrene-α-methylstyrene-acrylic acid-alkyl acrylate copolymers. As examples of usable surfactants include sodium hexametaphosphate, sodium polyacrylate and ammonium salt of styrene-acrylic acid copolymer.

Examples of a penetrant (surfactant) which can be added to pigment ink include anionic surfactants (such as sodium dodecylbenzenesulfonate, sodium laurate and ammonium salt of polyoxyethylene alkyl ether sulfate), nonionic surfactants (such as polyoxyethylene alkyl ether, polyoxyethylene alkyl ester, polyoxyethylene sorbitan fatty acid ester, polyoxyethylene alkyl phenyl ether, polyoxyethylene alkylamine and polyoxyethylene alkylamide) and acetylene glycol (such as Olefin Y, and Surfinol 82, 104, 440, 465 and 485, trade names, products of Air Products and Chemicals Inc.).

Polyhydric alcohols are added to pigment ink for the purposes of preventing the ink from clogging nozzles and assisting the ink in penetrating, so it is favorable for meeting these purposes that they have good water miscibility, high water retentivity, low vapor pressure (preferably below 0.01 nmHg) and a boiling point of from 120 to 380° C. Further, it is appropriate that their viscosity be from 2 to 1,000 cps at 25° C. As examples of such polyhydric alcohols, mention may be made of polyhydric alcohols, such as ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane and trimethylolpropane, alkyl ethers of polyhydric alcohols, such as ethylene glycol monoethyl ether, ethylene glycol monobutyl ether, diethylene glycol monomethyl ether, diehylene glycol monoethyl ether, triethylene glycol monoethyl ether and triethylene glycol monomethyl ether, urea, 2-pyrrolidone, N-methyl-2-pyrrolidone, 1,3-dimethyl-2-imidazolidinone and triethanolamine.

Examples of a low boiling organic solvent suitable for pigment ink include methanol, ethanol, n-propanol, iso-propanol, n-butanol, sec-butanol, tert-butanol, iso-butanol and n-pentanol.

In the pigment ink usable in the invention, a resin emulsion, saccharide, a pH adjusting agent, an antiseptic, an antimold and an antioxidant can further be mixed. Examples of resins suitable for such a resin emulsion include water-soluble (meth)acrylic acid resins, vinyl acetate resins, styrene-butadiene resins, vinyl chloride resins, acrylic-styrene resins, butadiene resins, styrene resins, cross-linked acrylic resins, cross-linked styrene resins, benzoguanamine resins, phenol resins, silicone resins, urethane resins and epoxy resins. And it is desirable for these resins to have a structure formed both of hydrophilic and hydrophobic parts.

As examples of saccharide which can be mixed in the pigment ink, mention may be made of monosaccharides, disaccharides, polysaccharides including oligosaccharides, and sugar alcohols thereof. Of these saccharides, glucose, mannose, fructose, ribose, xylose, arabinose, galactose, aldonic acid, glycitol, sorbitol, maltose, cellobiose, lactose, sucrose, trehalose, maltotriose, alginic acid, α-cyclodextrin and cellulose.

Examples of a composition of pigment ink suitable for the invention include the compositions disclosed in W099/05230, which each contain at least a coloring material, a water-soluble dispersant and a penetrant. More specifically, the cyan ink composition contains C.I.Pigment Blue 15:3 as the coloring material in a concentration of 2 to 4 weight %, the magenta ink composition contains C.I.Pigment Red 122 as the coloring material in a concentration of 3 to 5 weight %, the yellow ink composition contains C.I.Pigment Yellow 128 as the coloring material in a concentration of 3 to 5 weight %, the black ink composition contains carbon black as the coloring material in a concentration of 2 to 5 weight %, the orange ink composition contains C.I.Pigment Orange 43 or C.I.Pigment Orange 36 as the coloring material in a concentration of preferably 2 to 5 weight %, and the green ink composition contains C.I.Pigment Green 7 or C.I.Pigment Green 36 as the coloring material in a concentration of preferably 2 to 5 weight %.

Further, in each of these ink compositions are contained an acetylene glycol compound as penetrant in a concentration of 0.1 to 5 weight %, and a water-soluble styrene- (meth) acrylic resin as water-soluble dispersant in a proportion of 0.1 to 1 weight % to the pigment on a solids basis.

The entire disclosure of all application, patents and publications, cited above and below, and of corresponding Japanese application No.2000-094125, filed Mar. 31, 2000, are hereby incorporated by reference.

Now, the invention is illustrated in more detail by reference to the following examples. However, it should be understood that these examples are not to be construed as limiting the scope of the invention in any way. Unless otherwise noted, all “parts” and all “%” are by weight in the following examples and comparative examples.

With respect to the average size of colloidal silica particles used in each Example described below, the average size measurement of primary particles is carried out using a nitrogen adsorption method (BET method) and that of secondary particles is carried out using a dynamic light scattering method (laser method).

### EXAMPLE 1

Base Paper:

Ninety percent of hardwood bleached kraft pulp and 10% of softwood bleached kraft pulp were mixed, and beaten till the pulp mixture had a freeness of 350 ml in terms of csf (Canadian standard freeness). The resulting pulp was admixed with 4 parts of cationic starch, 0.3 parts of anionic polyacrylamide and 0.5 parts of an alkylketene dimer emulsion, and made into paper web in a conventional way using a Fourdrinier paper machine. The thus made paper web was dried by receiving three-stage wet press first, and then two-stage tension press in the drying section. Thereafter, a solution containing 5% of phosphorylated starch and 0.5% of polyvinyl alcohol was coated on the paper web so as to have a coverage of 3.6 g/m² on a solids basis by means of a size press, dried, and further subjected to machine caledering treatment. The base paper thus made had a basis weight of 175 g/m².

Ink-receiving Layer (Lower Layer):

A coating composition was prepared by mixing 100 parts of synthetic silica (FINESIL X-12, trade name, a product of Tokuyama Corp.), 25 parts of polyvinyl alcohol (PVA 117, trade name, a product of Kuraray Co., Ltd.), 5 parts of an ethylene-vinyl acetate copolymer emulsion (Sumikaflex 401, trade name, a product of Sumitomo Chemical Co., Ltd.), 5 parts of a styrene-butadiene latex (NIPOL LX438C, trade mane, a product of Nippon Zeon Co.), 10 parts of diallyldimethylammonium chloride-acrylamide copolymer (PAS-J-81, trade name, a product of Nitto Boseki Co., Ltd.), 0.3 parts of a defoaming agent (SN Defoamer), 0.005 parts of a blueing agent, 0.5 parts of a fluorescent dye and water in an amount required for adjusting a solids concentration to 18%. The coating composition thus prepared was coated on the base paper made in the foregoing manner by means of a bar blade coater so as to have a coverage of 3 g/m², and dried till the water content in the paper as a whole was reduced to 5%. The thus formed lower layer had a thickness of 5 μm.

Ink-receiving Layer (Outermost Layer):

On the lower ink-receiving layer formed in the foregoing manner, a coating composition constituted of 100 parts of colloidal silica having an average primary particle size of 20 nm and an average secondary particle size of 350 nm (CEP10AK97002, produced by CABOT CO., LTD.), 30 parts of polyvinyl alcohol (PVA 117, trade name, a product of Kuraray Co., Ltd.), 0.3 parts of a defoaming agent, 0.005 parts of a blueing agent and water in an amount require for adjusting a solids concentration to 20% was coated with a bar blade coater so as to have a coverage of 12 g/m². And the layer thus coated was dried till the total water content in the recording paper obtained was reduced to 5%. The thus formed outermost layer had a thickness of 15 μm.

### EXAMPLE 2

An ink-jet recording paper was produced in the same manner as in Example 1, except that the coverage of the coating composition prepared for a lower ink-receiving layer was increased to 7 g/m² and the lower ink-receiving layer having a thickness of 10 μm was formed.

### EXAMPLE 3

An ink-jet recording paper was produced in the same manner as in Example 1, except that the coverage of the coating composition prepared for a lower ink-receiving layer was increased to 20 g/m² and the lower ink-receiving layer having a thickness of 30 μm was formed.

### EXAMPLE 4

An ink-jet recording paper was produced in the same manner as in Example 1, except that the coating composition prepared for a lower ink-receiving layer was coated twice at a coverage of 20 g/m² and a coverage of 18 g/m² respectively. The lower ink-receiving layer of the recording paper thus obtained had a total thickness of 50 μm.

### EXAMPLE 5

An ink-jet recording paper was produced in the same manner as in Example 3, except that the coverage of the coating composition prepared for an outermost ink-receiving layer was reduced to 5 g/m². The outermost ink-receiving layer of the recording material thus obtained had a thickness of 5 μm.

### EXAMPLE 6

An ink-jet recording paper was produced in the same manner as in Example 3, except that the coverage of the coating composition prepared for an outermost ink-receiving layer was increased to 16 g/m². The outermost ink-receiving layer of the recording material thus obtained had a thickness of 20 μm.

### EXAMPLE 7

An ink-jet recording paper was produced in the same manner as in Example 6, except that the pigment used in the outermost ink-receiving layer was replaced by colloidal silica having an average primary particle size of 10 nm and an average secondary particle size of 250 nm (Snowtex PS-S, trade name, produced by Nissan Chemicals Co., Ltd.), and besides, the coverage of the coating composition prepared for an outermost ink-receiving layer was changed to 18 g/m². The recording paper thus obtained had an outermost ink-receiving layer measuring 20 μm in thickness.

### EXAMPLE 8

An ink-jet recording paper was produced in the same manner as in Example 6, except that the pigment used in the outermost ink-receiving layer was replaced by colloidal silica having an average primary particle size of 45 nm and an average secondary particle size of 480 nm (980001, produced by CABOT CO., LTD.), and besides, the coverage of the coating composition prepared for an outermost ink-receiving layer was changed to 14 g/m². The recording paper thus obtained had an outermost ink-receiving layer measuring 20 μm in thickness.

### EXAMPLE 9

A recording paper was produced in the same manner as in Example 1, except that the coating composition prepared for an outermost ink-receiving layer was coated twice at each coverage of 16 g/m². The recording paper thus obtained had an outermost ink-receiving layer measuring 40 μm in thickness.

### EXAMPLE 10

An ink-jet recording paper was produced in the same manner as in Example 1, except that the coating composition prepared for a lower ink-receiving layer was coated twice at each coverage of 20 g/m² and the coverage of the coating composition prepared for an outermost ink-receiving layer was decreased to 4 g/m². The recording paper thus obtained had a lower ink-receiving layer measuring 55 μm in thickness and an outermost ink-receiving layer measuring 5 μm in thickness.

### EXAMPLE 11

An ink-jet recording paper was produced in the same manner as in Example 1, except that the coating composition prepared for a lower ink-receiving layer was coated at a coverage of 20 g/m² and the coating composition prepared for an outermost ink-receiving layer was coated twice at each coverage of 16 g/m². The recording paper thus obtained had a lower ink-receiving layer measuring 30 μm in thickness and an outermost ink-receiving layer measuring 40 μm in thickness.

### COMPARATIVE EXAMPLE 1

An ink-jet recording paper was produced in the same manner as in Example 6, except that no lower ink-receiving layer was provided and the coating composition prepared for an outermost ink-receiving layer was coated directly on the base paper. The recording paper thus obtained had a single ink-receiving layer measuring 20 μm in thickness.

### COMPARATIVE EXAMPLE 2

An ink-jet recording paper was produced in the same manner as in Example 6, except that the lower ink-receiving layer was provided on the base paper but no outermost ink-receiving layer was provided thereon. The recording paper thus obtained had a single ink-receiving layer measuring 30 μm in thickness.

### COMPARATIVE EXAMPLE 3

An ink-jet recording paper was produced in the same manner as in Example 6, except that the pigment used in the outermost ink-receiving layer was replaced by fine silica gel slurry having an average primary particle size of 8 nm and an average secondary particle size of 390 nm (SMSG-3U GRACE, trade name, produced by Davison Co., Ltd.), and besides, the coverage of the coating composition prepared for an outermost ink-receiving layer was changed to 18 g/m². The recording paper thus obtained had a lower ink-receiving layer measuring 30 μm in thickness and an outermost ink-receiving layer measuring 20 μm in thickness.

### COMPARATIVE EXAMPLE 4

An ink-jet recording paper was produced in the same manner as in Example 6, except that the pigment used in the outermost ink-receiving layer was replaced by colloidal silica measuring 20 nm in both average primary particle size and average secondary particle size (Snowtex ST-20L, trade name, produced by Nissan Chemicals Co., Ltd.), and besides, the coverage of the coating composition prepared for an outermost ink-receiving layer was changed to 14 g/m². The lower ink-receiving layer and the outermost ink-receiving layer of the recording paper thus obtained had a thickness of 30 μm and a thickness of 20 μm respectively.

### COMPARATIVE EXAMPLE 5

An ink-jet recording paper was produced in the same manner as in Example 6, except that the pigment used in the outermost ink-receiving layer was replaced by colloidal silica having an average primary particle size of 20 nm and an average secondary particle size of 240 nm (Snowtex PS-MO, trade name, produced by Nissan Chemicals Co., Ltd.), and besides, the coverage of the coating composition prepared for an outermost ink-receiving layer was changed to 14 g/m². The lower ink-receiving layer and the outermost ink-receiving layer of the recording paper thus obtained had a thickness of 30 μm and a thickness of 20 μm respectively.

Evaluation Methods:

Performance evaluations of recording materials prepared in the foregoing Examples and Comparative Examples were made using the following methods. Additionally, the recording materials can be used in practice without any particular problems when rated Δ (fair) or above on each evaluation item.

In evaluating recorded image qualities, a commercial inkjet printer, Model EM-900C (trade name, a product of Seiko Epson Corp.), the cartridge of which were in advance refilled with a four-color ink set prepared by dispersing the following pigments respectively into the dispersing medium described below, was employed for producing graphic output in multiple colors on a recording paper to be tested. As to the physical properties of the four-color ink set used, the viscosity was from 3.0 to 3.8 mPa, the surface tension was from 30 to 40 N/m and the pH was from 8.0 to 8.8.

Pigment Contained in Ink (Concentration)

| | | |
|---|---|---|
| Yellow ink: | C.I. Pigment Yellow 128 | (3%) |
| Magenta ink: | C.I. Pigment Red 122 | (3%) |
| Cyan ink: | C.I. Pigment Blue 15:3 | (2%) |
| Black ink: | Carbon black | (4.5%) |

Composition of Dispersing Medium

| | |
|---|---|
| Ammonium salt of styrene-acrylic acid | 1.5% |
| copolymer (dispersant) | |
| Grandol PP-1000 (styrene-acrylic resin | 7% |
| emulsion, produced by DaiNippon Ink | |
| Co., Ltd.) | |
| Maltitol | 3% |
| Glycerin | 10% |
| Surfinol 465 (produced by AIR PRODUCTS Co.) | 0.9% |
| Ion exchange water | remainder % |

Evaluation Items:

Ink Absorption

A pattern constituted of areas solidly colored in red and those solidly colored in green which were arranged so as to border on one another was printed on each sample, and the extent of bleed on the borders was evaluated by visual observation according to the following criteria.

⊚: Borders are clear and no bleed is observed thereon

∘: Borders are a little unclear but practically no bleed is observed thereon

Δ: Borders are unclear and a little bleed is observed thereon

×: Borders unclear and much bleed is observed thereon

Color Reproduction

The black, cyan, magenta and yellow solid patterns printed was allowed to stand for one day, and then examined for their respective densities by means of a Macbeth densitometer, RD914 (made by MACBETH CO.). Color reproduction of each sample was evaluated by the sum total of measured values of those color densities.

⊚: Sum total of measured densities of four colors is 6 or above

∘: Sum total of measured densities of four colors is from 5 to below 6

Δ: Sum total of measured densities of four colors is from 4 to below 5

×: Sum total of measured densities of four colors is below 4

Cracking

The coating surface of each recording paper was observed under a stereomicroscope of a magnification of 50 times, and evaluated according to the following criteria:

⊚: No crack is observed

∘: Few cracks are observed

Δ: Cracks are observed on almost half the coating surface

×: Cracks are observed on almost all the coating surface

Coming-off in Powder

An A4-size sheet of each recording paper was cut 10 times along the width direction by means of an NT cutter, and the paper dust produced thereby was gathered and the weight thereof was measured. The tendency of the coatings to come off in powder was evaluated according to the following criteria:

⊚: Paper dust gathered has a weight of below 10 mg

∘: Paper dust gathered has a weight of from 10 mg to below 20 mg

Δ: Paper dust gathered has a weight of from 20 mg to below 40 mg

×: Paper dust gathered has a weight of 40 mg or above

Image Fastness

A black solid image was printed on one sheet of each recording paper, and allowed to stand for one day. Then, the density of this image (taken as A) was measured with a reflection densitometer, MACBETH RD914. The printed face of this sheet was brought into contact with the back of the other sheet, and these faces were rubbed together for 10 times using a fastness tester, Rubbing Tester (trade name, made by Suga Shikenki Co., Ltd.) in accordance with JIS P8136. The density of the thus rubbed image (taken as B) was measure with a reflection densitometer, MACBETH RD914. Image fastness was evaluated by a B×100/A value.

⊚: Image fastness is 90% or above

∘: Image fastness is from 70% to below 90%

Δ: Image fastness is from 50% to below 70%

×: Image fastness is below 50%

pH of Slurry

The surface layer of each recording paper was shaved off in an amount of about 5 mg by means of a single-edged safety razor, and the dry weight of shavings obtained was determined. Then, ion exchange water was added to the shavings in an amount required to adjust the concentration of a slurry obtained to 10%, stirred with a glass stick and examined for pH of the slurry.

The results of evaluations made above are shown in Table 1.

TABLE 1

| | Lower layer | Pigment in | | | | | | | |
|---|---|---|---|---|---|---|---|---|---|
| | thickness/ | Outermost layer | | | | | | | |
| | outermost | Primary | Secondary | Evaluation Results | | | | | |
| | layer | particle | particle | | | Color | | Coming- | |
| | thickness | size | size | pH of | Ink | repro- | | off in | Image |
| | (μm/μm) | (nm) | (nm) | Slurry | absorption | duction | Cracking | powder | fastness |
| Example 1 | 5/15 | 20 | 350 | 7.6 | ◯ | ◯ | ◯ | ⊚ | ◯ |
| Example 2 | 10/15 | 20 | 350 | 7.6 | ◯ | ⊚ | ◯ | ⊚ | ◯ |
| Example 3 | 30/15 | 20 | 350 | 7.6 | ◯ | ⊚ | ⊚ | ◯ | ◯ |
| Example 4 | 50/15 | 20 | 350 | 7.6 | ⊚ | ◯ | ⊚ | ◯ | ◯ |
| Example 5 | 30/5 | 20 | 350 | 7.2 | ◯ | ◯ | ⊚ | ⊚ | ◯ |
| Example 6 | 30/20 | 20 | 350 | 7.8 | ⊚ | ⊚ | ◯ | ⊚ | ◯ |
| Example 7 | 30/20 | 10 | 250 | 7.4 | ◯ | ⊚ | ◯ | ◯ | ◯ |
| Example 8 | 30/20 | 45 | 480 | 7.5 | ⊚ | ◯ | ◯ | ◯ | ◯ |
| Example 9 | 5/40 | 20 | 350 | 7.8 | Δ | ◯ | Δ | ◯ | ◯ |
| Example 10 | 55/5 | 20 | 350 | 7.6 | ◯ | Δ | ◯ | Δ | ◯ |
| Example 11 | 30/40 | 20 | 350 | 7.7 | ◯ | ◯ | Δ | Δ | ◯ |
| Comparative | —/20 | 20 | 350 | 7.6 | x | Δ | Δ | x | ◯ |
| Example 1 | | | | | | | | | |
| Comparative | 30/— | — | — | 5.3 | x | x | ⊚ | ⊚ | ◯ |
| Example 2 | | | | | | | | | |
| Comparative | 30/20 | 8 | 390 | 5.1 | Δ | ◯ | x | Δ | Δ |
| Example 3 | | | | | | | | | |
| Comparative | 30/20 | 20 | 20 | 7.5 | x | x | x | x | Δ |
| Example 4 | | | | | | | | | |
| Comparative | 30/20 | 20 | 240 | 4.9 | ◯ | x | ◯ | ◯ | Δ |
| Example 5 | | | | | | | | | |

As can be seen from Table 1, when images were printed thereon with the pigment ink-mounted printer, the ink-jet recording materials according to the invention showed excellent ink absorption and color reproduction, and besides, they were free from defects that the outermost coating layer produces cracks on the surface and comes off in powder, and the images printed thereon had highly satisfactory fastness.

What is claimed is:

1. An ink-jet recording material for pigment ink which has on a support at least two ink-receiving layer including the outermost ink-receiving layer and a lower ink-receiving layer, said outermost ink-receiving layer containing as main constituents a binder and a pigment having an average particle size of 30 to 500 nm and being constituted so that all constituents contained therein show a pH value of from 6.5 to 10 as a slurry solution prepared by dispersing them homogeneously in water in a total concentration of 10% by weight.

2. An ink-jet recording material as described in claim 1, wherein the pigment in the outermost ink-receiving layer is a pigment comprising secondary particles formed of fine primary particles having an average size of 5 to 60 nm.

3. An ink-jet recording material as described in claim 2, wherein the pigment is colloidal particles of silica, alumina, titanium oxide or zirconia.

4. An ink-jet recording material as described in claim 1, wherein the outermost ink-receiving layer has a thickness of 5 to 50 μm.

5. An ink-jet recording material as described in claim 1, wherein the lower ink-receiving layer has a thickness of 5 to 50 μm.

6. An ink-jet recording material as described in claim 1, wherein the lower ink-receiving layer comprises a pigment having an oil absorption of 100 to 300 cc/g.
